(19) United States
(12) Patent Application Publication
(10) Pub. No.: US 2001/0035121 A1
(43) Pub. Date: Nov. 1, 2001

(54) Stuffed toy novelty attachment for a remote control unit

(76) Inventor: Edward Eleazer Huling, Beavercreek, OH (US)

Correspondence Address: Edward E. Huling, 1590 Arrowwood Road, Beavercreek, OH, 45432, US

(21) Appl. No.: 09/833,156

(22) Filed: Apr. 11, 2001

Related U.S. Application Data
(60) Provisional application No. 60/197,422, filed on Apr. 14, 2000.

(51) Int. Cl. G09F 3/00

(52) U.S. Cl. 116/200; 116/209

(57) ABSTRACT

Plush stuffed toy novelty attachment for a remote control unit. The novelty provides a simple solution for keeping track of the remote control unit in a home and business environment. The novelty can be made from the same material and manner used for producing children's stuffed plush toys. The lightweight novelty enhances the visual obviousness of the location of the remote control unit while allowing unhindered use and operation. The novelty also hinders the remote control unit from sliding into furniture crevices and into the interior of the furniture. The shape, color pattern, and colors of the novelty may be customized to advertise schools, sports teams, businesses, and business products.

### CROSS-REFERENCE TO PRIOR APPLICATION

Provisional application for patent under 37 CFR 1.51 c was filed with the U.S. Patent and Trademark office entitled “Artificial Animal Tail Attachment for Remote Control”, U.S. Application No. 60/197,422; Filing Date: Apr. 14, 2000.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION:

1. Field Of Endeavor

This invention provides a stuffed toy novelty attachment for a remote control unit as method of keeping track of the remote control unit in a home and business environment. The stuffed toy novelty can be produced in a shape and colors as a method of advertising a school, sports team, business, or business products.

2. Description of Information

The remote control unit for the family television, videocassette recorder, digital videodisk, or stereo sound system is often misplaced in a home environment. Remote control units are hand-held, relatively small, thin, flat or are slightly rounded, and are typically black in color. Because of the small size, flat or rounded bottoms, remote control units can slip and slide between the cushions of a sofa or upholster recliner, become lost in bed clothes and under coffee table magazines, or inadvertently be carried away and left in another room. Remote control units may be placed in an unusual location where the owner has difficulty locating them. In many cases, because of the small size and neutral color, remotes can also be in plain sight but difficult to locate. The phrase, “where's the remote?” is a familiar phrase in many homes. What is needed is method or device, which permits the owner to easily and quickly locate the remote control unit upon entering a room. This is a problem addressed by several patents. Prior art identifies various devices to prevent loss or locate a misplaced remote control unit. Several patents have been granted to inventors for devices to locate or find lost items. One of the most common methods of keeping track of a remote control units that has several U.S. Patents is to activate an alarm on the item using a radio signal. The user has access to a transmitter and a small receiver is attached to the item to be located. The user activates the transmitter and a signal is sent to the receiver on the item. The receiver in turn activates an alarm, giving the user an indication as to the location of the item. U.S. Pat. Nos. 4,101,873, 4,476,469, 4,507,653, 4,598,272 and 4,591,835 are early applications for item locators with electronic receiver/transmitters.

An interesting approach to finding lost articles is U.S. Pat. No. 4,507,653, which uses only an electronic receiver. The receiver is responsive to specific sounds, such as clapping, which activates an alarm. A sound detecting and indicating circuit provides the audible tones upon receiving of a sequence of sounds. In effect, the user becomes the transmitter. U.S. Pat. No. 5,648,757 is a remote control unit protective holder and detection device. In addition to bumper pads to protect the remote control should it be dropped, the holder includes electronic circuitry, which alarms when a television set is turned on. The circuit is capable of detecting a change in electromagnetic fields generated by a television set being turned on. Additionally, the holder includes movement detection circuitry. In a situation where a remote control unit is lost between the sheets, simple movement will cause the holder to alarm. U.S. Pat. No. 5,939,981 is a device that can assist in locating several objects, including locating a remote control unit. The device is comprised of two parts; a hand held device and multiple sensors/chip which are applied to objects that the user desires to locate. The hand held device contains a control panel with object selector buttons for each sensor/chip applied to the object to be found. Using a handheld unit with article selection buttons functioning to transmit a code to a second device located with the desired object. The hand held unit has a direction finding capability that causes the object to emit a sound when the hand held unit is pointed at it and stop when is not pointed at it. Additionally, the sound becomes louder the closer the hand held device is to the sensors/chip.

More recently, U.S. Pat. No. 5,945,918 enables a user to find a missing remote control unit by using a transmitter that is build into the television cabinet, or housed in a separate unit attached to the cabinet. The device is similar to those above—when the transmitter is activated, an alarm (sound or light) emits from the lost remote control unit, allowing the unit to be located by the user. This device has a few advantages—the loudness of the alarm signal varies with the strength of a signal received from the transmitter. The device also includes an indicator showing the user that the transmitter is emitting a signal. Thus, if the remote control is not located, the user will know the failure is not from the transmitter. Additionally, this device is designed to prolong the effective life of the battery, which powers the circuit.

In addition to expense, electronic methods of locating a lost remote control unit in the prior art has some problems:

a) The transmitter itself can become lost or misplaced, or fail to operate. Or, in the case of a remote control unit carried into another room, may not be close enough to the receiver to activate the alarm.

b) In the case of an electronic transmitter/receiver, once electronic device is used to find another, and the transmitter itself can be misplaced or inconvenient to use.

c) Electronic devices require electrical power or batteries, which necessitates the user periodically replace the batteries as they wear out. Keeping track of when the batteries need changing becomes inconvenient and expensive.

d) Another disadvantage is that these systems take time to operate. After determining the remote control unit is lost or misplaced, the user must find and operate the transmitter. Electronic methods do not always provide an immediate location.

e) Do not prevent the remote control unit from becoming misplaced or lost in the first place.

f) Do not slow the remote control unit from slipping into furniture crevices (i.e., between cushions and possibly into interior of a sofa or cushioned chair).

U.S. Pat. No. 4,386,371, proposes connecting the remote control unit to the TV set by a wire. This simple solution does solve the problem of keeping track of a remote control unit and prevents loss or misplacement. However, it is very inconvenient to maintain a wire connection between the remote control unit and the TV set. A wire can represent a safety hazard in a home with children and limit operation of the remote control unit.

Prior art includes several devices for locating the remote control units after they have been misplaced. In addition, there are several patented devices in prior art that provide a holder for remote control units to prevent them from coming lost or misplaced in the first place. U.S. Pat. No. 5,195,634 uses an enlarged enclosure, where the remote control unit is placed when not in use. These types of devices can limit accessibility and requires a strict routine of putting the remote away when done. U.S. Pat. No. 5,192,042 addresses both a television and videocassette recorder remote control units. The two control units are coupled back-to-back in a bulky arrangement, thereby keeping the remote controls together. U.S. Pat No. 5,244,173 discloses a holder in the form of a stand for placement of RCU. U.S. Pat. No. 4,815,683 identifies another holder, which is a container that is secured to the side of a television and videocassette recorder. Holders in a disciplined environment work well as long as all users return the remote control unit to the holder after use.

Remote controls are typically used in soft furniture environments (i.e. beds, pillows, upholstered sofas and couches, and large cushioned chairs) which are primarily in a home's television room, living room, and bedroom; a location where a person might recline and lounge while using a remote control unit. This type of environment may also include soft stuffed novelties, such as stuffed animals or caricature figures, which are familiar toys and give pleasure to adults as well as children. Stuffed novelties typically have a plush composition and appealing design, and are well know in the prior art. Fabric backed pile fiber materials present a fur-like appearance, which is desirable in stuffed children's toys, and simulates the feel and resiliency of living animals. Stuffed toys have been known to share both a bed and couch, and rarely get lost by falling through the crevices of furniture, in contrast to a remote control unit. Additionally, children usually have little trouble with maintaining awareness of the location of their favorite stuffed animal. It is desirable to have a device that combines both features of a stuffed animal and a remote control unit, which can be easily found and operated by the user.

A plush stuffed animal or animal appendage attached to a remote control unit is a novel combination of features and is believed to be unknown in the art. However, there are examples in the art of using stuffed toys in combination with other devices to perform certain functions. U.S. Pat. No. 6,142,846, entitled “Stuffed Animal Toy,” relates a stuffed animal toy in combination with a flashlight embedded in the animal's arm or leg for use by a child. This combines both features of a stuffed animal and a directional light suitable for operation by the child. This practical combination associates the stuffed animal with a flashlight, easily found and used by a child.

U.S. Pat. No. 5,072,998 entitled “Stuffed Anatomical Members,” invented by Mr. Bobby Y. Oh, mounts plush stuffed anatomical members on a computer monitor representing the head, two arms, feet, where the monitor represents the trunk of the figure. The purpose of the device is to help personalize the computer monitor to a child, and makes an otherwise impersonal computer monitor attractive to a child.

### BRIEF SUMMARY OF THE INVENTION

My invention provides a simple and reliable method of keeping track of a remote control unit. The invention solves several of the problems identified under “Background of the Invention” above and has several advantages:

a) Electronic devices are used primarily after the remote control unit becomes lost or misplaced. The stuffed toy novelty can prevent the remote control from becoming lost or misplaced in the first place. A remote control unit with an attached brightly colored stuffed toy novelty is much more visible than a remote control unit alone. The stuffed toy novelty enhances the visual obviousness of the location of the remote control unit. The stuffed toy novelty enhances the length, size and color of the remote control, providing a strong visual cue by association (of the novelty with the remote control unit) on the location of the remote control. The tail provides an alternative method, vice the remote control unit alone, for maintaining visual cognizance of the remote control unit.

b) Electronic methods also take time to operate. It takes much less time to visually scan a room looking for a larger stuffed toy novelty than operating a electronic transmitter/receiver device. Additionally, if the remote is carried into and left in another room, the remote control unit and stuffed toy novelty combination provide a strong visual cue on location of the remote.

c) Remote control unit holders require a disciple where the remote control unit must be replaced in the holders after use. In contrast to remote control holders, a combined stuffed toy novelty and remote control unit may be left anywhere in a room and can easily be found upon a quick visual scan of the room.

d) Stuffed toy novelties are inexpensive, light and flexible and do not require batteries or high maintenance. In comparison to a line or cable tied to the remote, a lightweight, flexible, soft, stuffed toy novelty attached to the rear-end of a remote control unit will not hinder its use or operation, and can easily be carried to any location within a room. Additionally, the plastic clip attached to the remote control unit allows the stuffed toy novelty to be easily removed from the remote for cleaning or replacement. The soft stuffed novelty can be sat or laid upon with no injury and little discomfort making it a welcome addition to a living room or soft furniture environment.

e) Electronic devices do not prevent remote control units from slipping in-between the cushions or falling into the interior of an upholstered couch or chair. After use, a remote control unit may be laid on the furniture next to the user. As the user moves on the furniture jostling the cushions, the remote control unit may slide into the crevices of the furniture. The stuffed toy novelty attachment provides more surface areas, thus acts like an anchor and hinders the slippage of a remote control unit into furniture crevices or between cushions and perhaps into the interior frame of the furniture. Even if the remote control unit should slip into a furniture crevice, a portion of the stuffed toy novelty will typically remain visible, thus allowing easier retrieval of the remote control unit. The stuffed toy novelty plus remote control unit combination is longer in length than a remote control unit alone, increasing the probability that a portion will remain visible from underneath magazines or throw pillows.

Accordingly, besides the objects and advantages of the device and method described above, several advantages and objects of the invention are:

a) to provide a simple solution to keeping track of a household remote control unit, which is inexpensive and solves some of the problem recited above.

b) to provide a visual means for quickly appraising a user of the location of the remote control unit within a living room, bed room, television room, or business type environment.

c) to provide a novelty of sufficient size, shape and colors to substantially enhance cognition and provide a visual cue by association on the location of said remote control unit in a home and business environment.

d) to provide a novelty of sufficient size and surface area to hinder slippage of the remote control unit into furniture crevices and to enhance locating and retrieval of the remote control unit from furniture crevices.

e) to provide a three-dimensional stuffed toy novelty that is made from soft pile fabric and stuffing with a fur-like appearance and therefore suitable for a living room and soft furniture environment.

f) to provide a simple method of attaching the stuffed novelty to a remote control unit while allowing easy removal of the stuffed novelty for cleaning or for replacement.

g) to provide a stuffed toy novelty and means of attachment that allows unhindered use and operation of the remote control unit.

h) to provide a low maintenance and low maintenance cost system that avoids batteries

i) to provide different styles and colors of novelties so a multi-remote control unit environment can use a different novelty for each remote control unit.

Further objects and advantages of my invention will become apparent from consideration of the drawings and ensuing description. It is to be understood, however, that the drawings are designed solely for the purposes of illustration and not as a definition of the limits of the invention.

### DESCRIPTION OF THE SEVERAL VIEW OF THE DRAWINGS

FIG. 1: Perspective view of fox-like tail attached to remote control unit.

FIG. 2: Side view of fox-like tail attached to a remote control with tail draping over edge of flat surface.

FIG. 3: Body end view of fox-like tail on flat surface showing looped.

Reference numbers in drawing:

1 Fox-tail like stuffed toy novelty

2 Remote control unit

3 Adhesive back wire clip

4 Cord

### DETAILED DESCRIPTION OF THE INVENTION

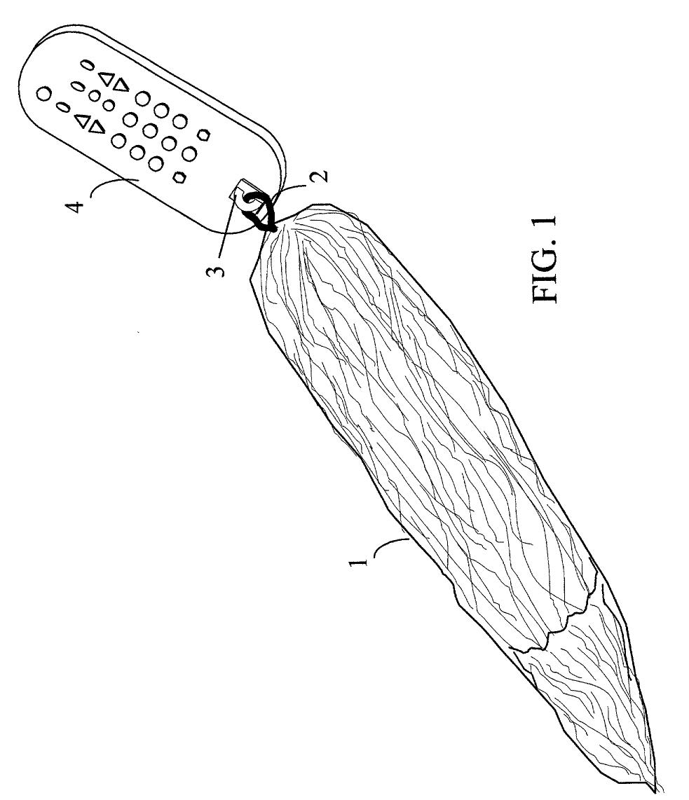

Referring now to the drawings, FIG. 1 shows a preferred embodiment of a stuffed toy novelty attachment for a remote control unit. The invention calls for a stuffed fox-like toy tail 1, a looped cord 2 attached to the body end of the tail (vice the tip of the tail), and an adhesive-backed clip 3 for mounting the tail to a remote control unit 4.

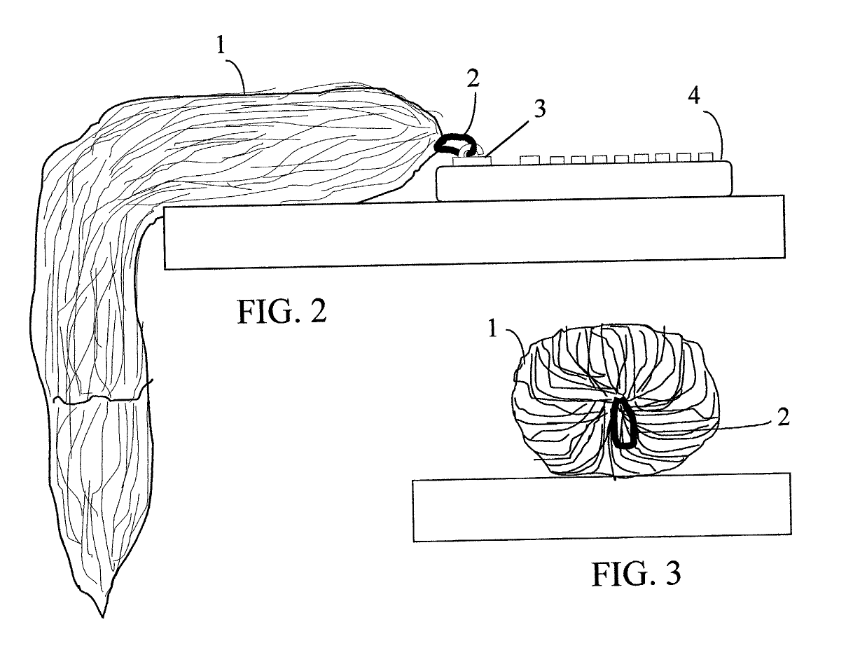

The tail can be made from the same material and manner used for producing children's stuffed plush toys. The plush fabric can be in bright or natural colors, single or multiple colored. The tail will have a life-like feel, texture and bushy fur-like appearance, and is comprised of several pieces of plush fabric material joined together to form a closed plush fabric receptacle having the shape and color pattern of a fox-like tail. The tail is lightly stuffed with a soft, resilient material such as cotton, flexible polyurethane or similar suitable material, to provide fullness to the tail but also allow draping the tail over the edge of a table as in FIG. 2. The tail is lightweight and allows unhindered operation and use of the remote while the circumference of the tail provides sufficient bulk to slow or prevent the remote from slipping completely through a furniture crevice and into the interior of the furniture. The tail itself acts as a visual cue as to the location of the remote control unit and provides a method of maintaining visual cognizance of the remote control unit. Most schools, sports teams and business have two colors that represent their organization. The color pattern of the pile fabric fox-like tail can be shaded in different colors to represent a school, sport team, or business, further enhancing cognizance and familiarity. The shape, color pattern, and colors of the novelty may be varied to represent a method of advertising. Additionally, in situations with more than one remote control unit, the tail attachments can be color coded to represent separate remote control units. There is a flexible cord that is mounted within the body of the tail so as to extend out the body end of the tail, vice the tip of the tail, forming a loop. The looped cord is securely mounted within the interior lining of the tail. The loop is of sufficient length to fit within the clip as illustrated in FIG. 1 and of sufficient diameter to remain within the closed clip. The flexible cord allows the tail to drape upon handling the remote, providing unhindered use of the remote control unit. An adhesive backed plastic or neoprene wire clip are common, where a protective covering can be peeled from the bottom mating surface, thereby exposing a layer of adhesive. This permits the user to simply peel off the protective layer and attach the clip-mating surface to any desired surface. This is the manner of attachment contemplated for the remote control unit. The clip will firmly stick to a semi-flat surface on the remote control. Typical location for the clip is on the bottom of the remote control unit, with the clip opening facing towards the front of the remote control as illustrated in FIG. 2. Although several brands of remote control units are on the open market, almost all provide a space at the top rear end of the remote control unit—this space is typically free of control function buttons, and is the best location for the wire clip. A cord looped at the end of the said tail can be slipped into the clip for attaching the tail to the remote control unit. The tail can be removed from the remote control unit by gently pulling back on the clip arch and slipping the looped cord out of the clip. The clip allows easy removal of the tail for cleaning, washing, or installing a new tail.

Although the description above contains many specifications, these should not be construed as limiting the scope of the invention but as merely providing illustrations of the presently preferred embodiment of the invention. Examples include: the plush polyester tail can have other shapes and colors and be produced from other materials than identified; several alternatives exists to the adhesive backed wire clips and looped cord to attach the stuffed tail to the remote control unit. Additionally, the shape of the stuffed novelty could include complete animals or other representations, and the attachment to the remote control unit could use a different adhesive or plastic clip. Thus the scope of the invention should be determined by the appended claims and their legal equivalents, rather than by the examples given.

What I claim as my invention is:

1. A remote control unit attachment comprised of a stuffed toy novelty and attachment means of said novelty to said remote control unit whereby said novelty provides a substantial visual cue on the location of said remote control unit in a home environment and hinders said remote control unit from sliding into furniture crevices and enhances retrieval of said remote control unit from said furniture crevices.

2. The novelty of claim 1 wherein said novelty is of sufficient size, shape and colors, to substantially enhance cognition and provide the visual cue by association with said novelty on the location of said remote control unit in a home environment.

3. The novelty of claim 1, further including novelties having a shape similar to fox tails and a fox tail-like pattern.

4. The novelty of claim 3 wherein colors may be combined and patterned to represent a school, represent a sports team, or represent a business whereby unique colors and patterns will enhance cognition and thus location of the remote.

5. The novelty of claim 3 wherein one end of said novelty includes a cord securely attached within said pile fabric providing a cord loop for attaching said novelty.

6. The novelty of claim 1 wherein said novelty is of sufficient size and surface area to hinder slippage of said remote control unit into furniture crevices and to enhance location and retrieval of said novelty and said remote control unit from furniture crevices.

7. The novelty of claim 1 wherein said novelty is comprised of a pile fabric covering with suitable filling material whereby making said novelty suitable for a soft furniture environment.

8. The attachment means of claim 1 wherein said attachment means allows removal and reattachment of said novelty from said remote control whereby said stuffed toy novelty can be wholly detached for replacing or for cleaning.

9. The attachment means of claim 1 wherein said novelty is attached to said remote control unit allowing said novelty to hang loosely from said remote control unit whereby allowing unhindered operation and use of the remote control unit.

10. A stuffed toy novelty for attaching to a remote control unit comprising:
